(19) United States
(12) Patent Application Publication
(10) Pub. No.: US 2020/0294093 A1
(43) Pub. Date: Sep. 17, 2020

(54) COMPUTER DETERMINED ELECTRONIC OFFERS BASED ON TRAVEL PATHS

(71) Applicant: VISA INTERNATIONAL SERVICE ASSOCIATION, San Francisco, CA (US)

(72) Inventor: Phan Huong Ly, Kallang Heights (SG)

(21) Appl. No.: 16/351,812

(22) Filed: Mar. 13, 2019

(51) Int. Cl. G06Q 30/02; G06N 20/00

(52) U.S. Cl. CPC G06Q 30/0266; G06Q 30/0205; G06N 20/00; G06Q 30/0254; G06Q 30/0264

(57) ABSTRACT

The path the consumer takes on a commute may be determined and merchants that desire the group of consumers and that are on the commuting path may allow merchants to provide advertisements and offers to desired consumer group that have indicated they desire offers and advertisements.

### BACKGROUND

People commute on public transportation on a daily basis. Often times, the path to and from the destination is the same day after day. Other times it changes as the tasks of each day may vary.

Modern public transportation systems may allow a user to use electronic payments to pay for transportation. The data collected may include a starting point, a starting time, an ending point and an ending time. Similarly, a variety of entities in the electronic commerce flow may collect data on purchases. However, the people in transit often are not known to the merchants on the travel path and based on a purchase history, the commuters may be desirable to the merchants on the commuting path.

### SUMMARY

The system and method may group consumers based on their spending habits. The path the consumer takes on a commute may be determined and merchants that desire the group of consumers and that are on the commuting path may allow merchants to provide advertisements and offers to desired consumer group that have indicated they desire offers and advertisements.

### BRIEF DESCRIPTION OF THE DRAWINGS

FIG. 1 may illustrate a sample computing system.

FIG. 2 may illustrate a method in accordance with the claims of the disclosure;

FIG. 3 may be an illustration of machine learning using training data;

FIG. 4A may be an illustration of machine learning using training data;

FIG. 4B may be an illustration of machine learning using training data;

FIG. 5 may be a sample user interface to select elements of interest to a merchant;

FIG. 6 may be an illustration of a sample computer used in the system and method;

FIG. 7 may be an illustration of possible paths; and

FIG. 8 may be an illustration of setting priorities in setting a path.

### SPECIFICATION

The present system, method and tangible memory device now will be described more fully with reference to the accompanying drawings, which form a part hereof, and which show, by way of illustration, specific exemplary embodiments by which the system, method and tangible memory device may be practiced. These illustrations and exemplary embodiments are presented with the understanding that the present disclosure is an exemplification of the principles of one or more system, method and tangible memory devices and is not intended to limit any one of the system, method and tangible memory devices to the embodiments illustrated. The system, method and tangible memory device may be embodied in many different forms and should not be construed as limited to the embodiments set forth herein; rather, these embodiments are provided so that this disclosure will be thorough and complete, and will fully convey the scope of the system, method and tangible memory device to those skilled in the art. Among other things, the present system, method and tangible memory device may be embodied as methods, systems, computer readable media, apparatuses, components, or devices. Accordingly, the present system, method and tangible memory device may take the form of an entirely hardware embodiment, an entirely software embodiment, or an embodiment combining software and hardware aspects. The hardware may be local, may be remote or may be a combination of local and remote. The following detailed description is, therefore, not to be taken in a limiting sense.

People commute on public transportation on a daily basis. For some people, the path to and from the destination is the same day after day. For other people, the path may change as the tasks of each day may vary. By observing the travel habits, predictions may be made on the path a commuter may take each day.

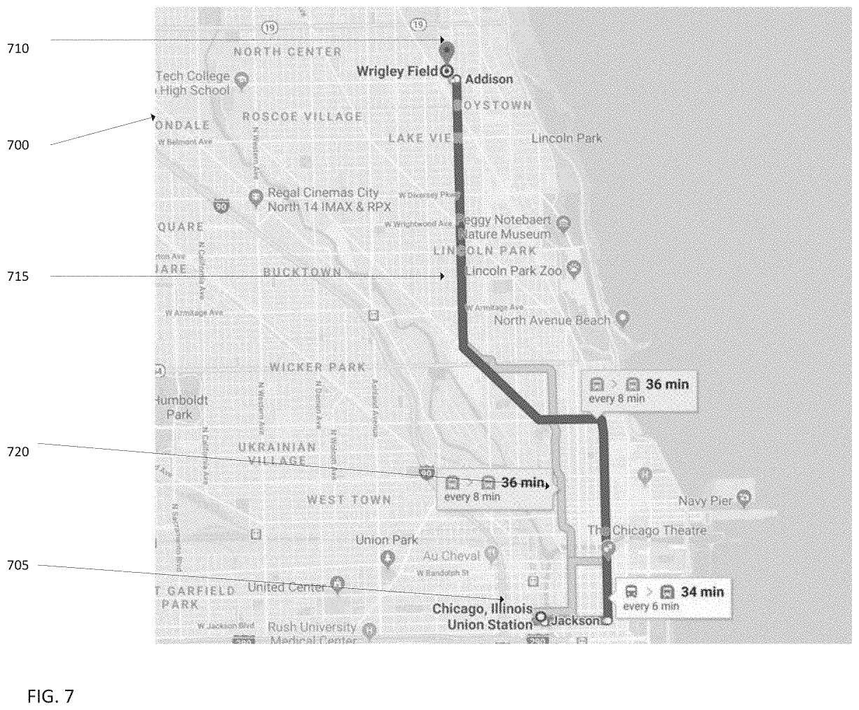

Modern public transportation systems may allow a user to use electronic payments to pay for transportation. The data collected may include a starting point, a starting time, an ending point and an ending time. Similarly, a variety of entities in the electronic commerce flow may collect data on purchases. However, the people in transit often are not known to the merchants on the travel path and based on a purchase history, the commuters may be desirable to the merchants on the commuting path. For example, briefly referring to FIG. 7, a merchant on a first path 715 may not have a strong desire to communicate with commuters on the second path 720.

The system and method may group consumers based on their spending habits. The path the consumer takes on a commute may be determined and merchants that desire the group of consumers and that are on the commuting path may allow merchants to provide advertisements and offers to desired consumer group that have indicated they desire offers and advertisements.

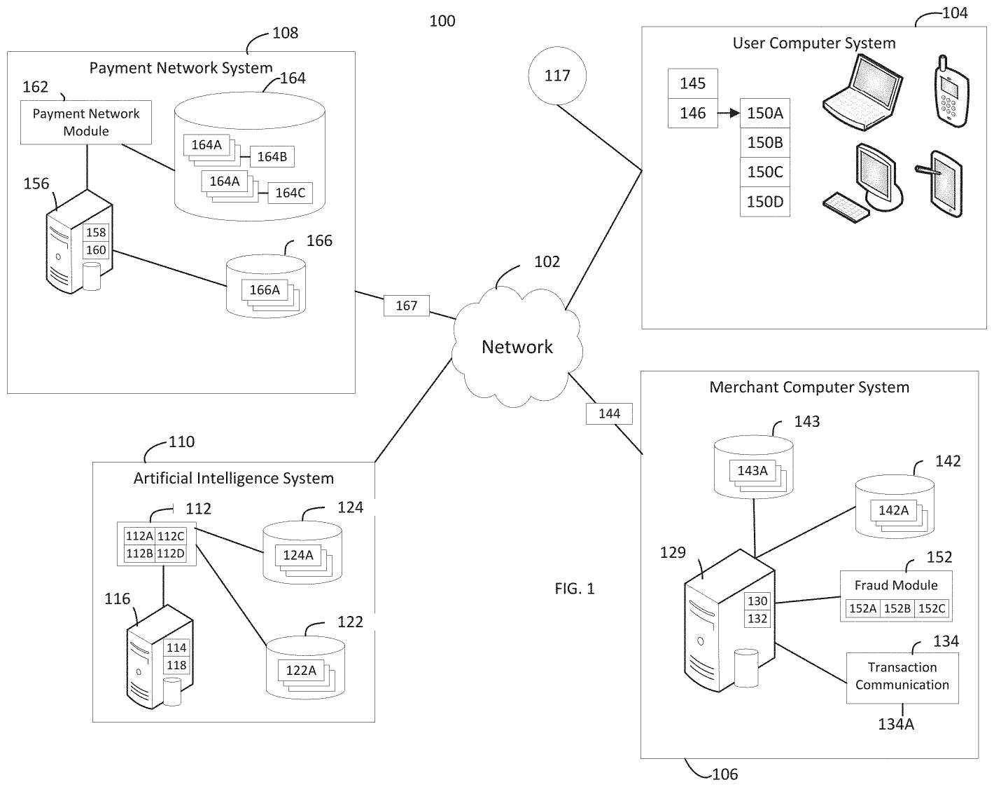

Referring to FIG. 1 which may be an illustration of the system in accordance with the claims, private network. FIG. 1 generally illustrates one embodiment of a private network such as a payment system that may require updates and system updates. The system 100 may include a computer network 102 that links one or more systems and computer components. In some embodiments, the system 100 includes a user computer system 104, a merchant computer system 106, a payment network system 108, and a transaction analysis system which may embody artificial intelligence 110.

The network 102 may be described variously as a communication link, computer network, internet connection, etc. The system may include various software or computer-executable instructions or components stored on tangible memories and specialized hardware components or modules that employ the software and instructions to identify related transaction nodes for a plurality of transactions by monitoring transaction communications between users and merchants.

The various modules may be implemented as computer-readable storage memories containing computer-readable instructions (i.e., software) for execution by one or more processors of the system 100 within a specialized or unique computing device. The modules may perform the various tasks, methods, blocks, sub-modules, etc., as described herein. The system 100 may also include both hardware and software applications, as well as various data communications channels for communicating data between the various specialized and unique hardware and software components.

Networks are commonly thought to comprise the interconnection and interoperation of hardware, data, and other entities. A computer network, or data network, is a digital telecommunications network which allows nodes to share resources. In computer networks, computing devices exchange data with each other using connections, i.e., data links, between nodes. Hardware networks, for example, may include clients, servers, and intermediary nodes in a graph topology. In a similar fashion, data networks may include data nodes in a graph topology where each node includes related or linked information, software methods, and other data. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications or data network. A computer, other device, set of related data, program, or combination thereof that facilitates, processes information and requests, and/or furthers the passage of information from a source user to a destination user is commonly referred to as a “node.” Networks generally facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

A user computer system 104 may include a processor 145 and memory 146. The user computing system 104 may include a server, a mobile computing device, a smartphone, a tablet computer, a Wi-Fi-enabled device, wearable computing device or other personal computing device capable of wireless or wired communication, a thin client, or other known type of computing device. The memory 146 may include various modules including instructions that, when executed by the processor 145 control the functions of the user computer system generally and integrate the user computer system 104 into the system 100 in particular. For example, some modules may include an operating system 150A, a browser module 150B, a communication module 150C, and an electronic wallet module 150D. In some embodiments, the electronic wallet module 150D and its functions described herein may be incorporated as one or more modules of the user computer system 104. In other embodiments, the electronic wallet module 150D and its functions described herein may be incorporated as one or more sub-modules of the payment network system 108. In some embodiments, a responsible party 117 is in communication with the user computer system 104.

In some embodiments, a module of the user computer system 104 may pass user payment data to other components of the system 100 to facilitate determining a real-time transaction analysis determination. For example, one or more of the operating system 150A, a browser module 150B, a communication module 150C, and an electronic wallet module 150D may pass data to a merchant computer system 106 and/or to the payment network system 108 to facilitate a payment transaction for a good or service. Data passed from the user computer system 104 to other components of the system may include a customer name, a customer ID (e.g., a Personal Account Number or “PAN”), address, current location, and other data.

The merchant computer system 106 may include a computing device such as a merchant server 129 including a processor 130 and memory 132 including components to facilitate transactions with the user computer system 104 and/or a payment device via other entities of the system 100. In some embodiments, the memory 132 may include a transaction communication module 134. The transaction communication module 134 may include instructions to send merchant messages 134A to other entities (e.g., 104, 108, 110) of the system 100 to indicate a transaction has been initiated with the user computer system 104 and/or payment device including payment device data and other data as herein described. The merchant computer system 106 may include a merchant transaction repository 142 and instructions to store payment and other merchant transaction data 142A within the transaction repository 142. The merchant transaction data 142A may only correspond to transactions for products with the particular merchant or group of merchants having a merchant profile (e.g., 164B, 164C) at the payment network system 108.

The merchant computer system 106 may also include a product repository 143 and instructions to store product data 143A within the product repository 143. For each product offered by the merchant computer system 106, the product data 143A may include a product name, a product UPC code, an item description, an item category, an item price, a number of units sold at a given price, a merchant ID, a merchant location, a customer location, a calendar week, a date, a historical price of the product, a merchant phone number(s) and other information related to the product. In some embodiments, the merchant computer system 106 may send merchant payment data corresponding to a payment device to the payment network system 108 or other entities of the system 100, or receive user payment data from the user computer system 104 in an electronic wallet-based or other computer-based transaction between the user computer system 104 and the merchant computer system 106.

The merchant computer system 106 may also include a fraud module 152 having instructions to facilitate determining fraudulent transactions offered by the merchant computer system 106 to the user computer system 104. Thus, the transaction volume analysis and location information may be accurate.

The fraud API 152A may include instructions to access one or more backend components (e.g., the payment network system 108, the artificial intelligence engine 110, etc.) and/or the local fraud module 152 to configure a fraud graphical interface 152B to dynamically present and apply the transaction analysis data 144 to products or services 143A offered by the merchant computer system 106 to the user computer system 104. A merchant historical fraud determination module 152C may include instructions to mine merchant transaction data 143A and determine a list of past fraudulent merchants to obtain historical fraud information on the merchant.

The payment network system 108 may include a payment server 156 including a processor 158 and memory 160. The memory 160 may include a payment network module 162 including instructions to facilitate payment between parties (e.g., one or more users, merchants, etc.) using the payment system 100. The module 162 may be communicably connected to an account holder data repository 164 including payment network account data 164A.

The payment network account data 164A may include any data to facilitate payment and other funds transfers between system entities (e.g., 104, 106). For example, the payment network account data 164A may include account identification data, account history data, payment device data, etc. The module 162 may also be communicably connected to a payment network system transaction repository 166 including payment network system global transaction data 166A.

The global transaction data 166A may include any data corresponding to a transaction employing the system 100 and a payment device. For example, the global transaction data 166A may include, for each transaction across a plurality of merchants, data related to a payment or other transaction using a PAN, account identification data, a product or service name, a product or service UPC code, an item or service description, an item or service category, an item or service price, a number of units sold at a given price, a merchant ID, a merchant location, a merchant phone number(s), a customer location, a calendar week, and a date, corresponding to the product data 143A for the product that was the subject of the transaction or a merchant phone number. The module 162 may also include instructions to send payment messages 167 to other entities and components of the system 100 in order to complete transactions between users of the user computer system 104 and merchants of the merchant computer system 106 who are both account holders within the payment network system 108.

The artificial intelligence or machine learning engine 110 may include one or more instruction modules including a transaction analysis module 112 that, generally, may include instructions to cause a processor 114 of a transaction analysis server 116 to functionally communicate with a plurality of other computer-executable steps or sub-modules, e.g., sub-modules 112A, 112B, 112C, 112D and components of the system 100 via the network 102. These modules 112A, 112B, 112C, 112D may include instructions that, upon loading into the server memory 118 and execution by one or more computer processors 114, dynamically determine transaction analysis data for a product 143A or a merchant 106 using various stores of data 122A, 124A in one more databases 122, 124. As an example, sub-module 112A may be dedicated to dynamically determine transaction analysis data based on transaction data associated with a merchant 106.

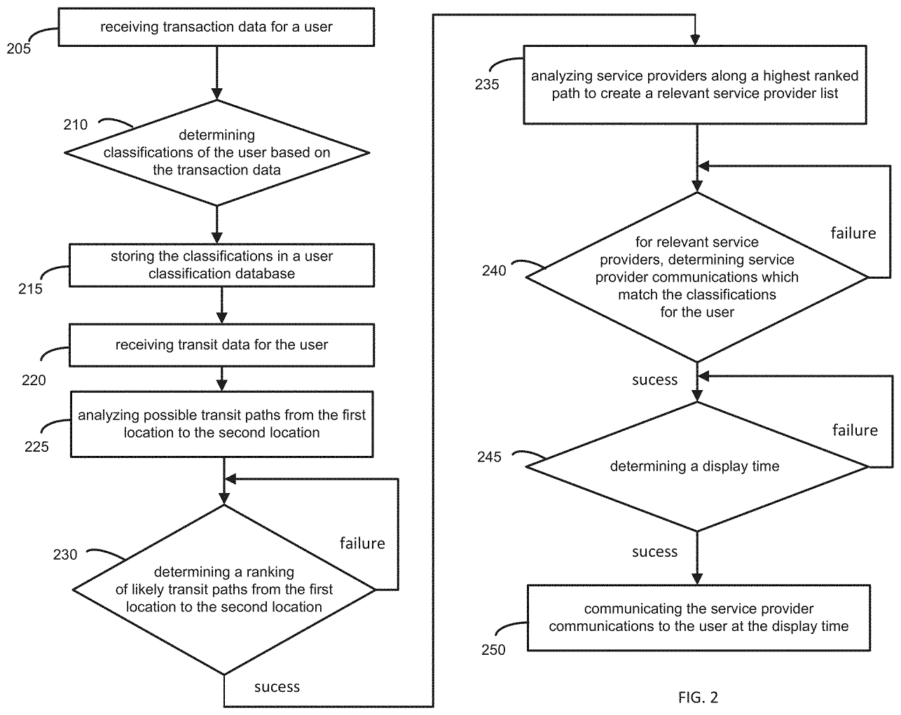

FIG. 2 may illustrate a sample method that may physically configure a processor as part of the system. At block 205, transaction data may be received for a user. The transaction data may vary depending on the source of the data but at a minimum may contain a consumer identifier. For example, a payment card issue may only have a limited amount of data such as an amount of a transaction and a merchant id. In other situations, the transaction data may come from a card clearance entity and the data may be more detailed such as including the good or service purchased, the amount of the purchase and an identification of the purchaser. In addition, in some embodiments, data from a first source may be combined with a second or third source to create a more complete picture of a consumer and the consumer purchase habits.

At block 210, classifications of the user based on the transaction data may be determined. The determination of classification may take a variety of form and may be determined in a variety of ways. In some embodiments, the classification may be based on monthly purchase levels. The classifications may be based on having an even number of people in each classification. In other embodiments, a desired range of purchasers may be further broken into classifications.

In other embodiments, classifications may be created using additional information available. For example, some entities in the electronic commerce chain may access to the merchant selling the good or service. The merchant may have meaning as people that purchase from an upscale merchant may be desirable to upscale merchant while people that purchase from discount merchants may be desirable to discount merchants. Logically, the consumers may be broken into groups based on the type of merchants they typically make purchases. As yet another example, in some situations, descriptions of the goods or services purchased may be available to entities in the electronic commerce chain and the description of the goods and services may be of use to predict future purchase habits and whether offers or advertisements might be effective. Thus, the consumers may be broken into categories based on the goods or services they purchased.

In another example, determining classifications of the user based on the transaction data may entail receiving a set of transaction data for a plurality of users, and an algorithm may be used which learns from past relevant data sets to perform an analysis of the transaction data for the users according to a criteria and may separate the plurality of users into groups based on the analysis. The algorithm may use machine learning to refine the categories of the individuals over time.

In other embodiments, merchants may create classifications themselves and the classifications may be applied to the transaction data to separate consumers into the desired merchant classifications. For example, a discount shoe store may desire the classifications to be based on the type of shoe store at which the consumer has purchased shoes in the past year. In this way, the classifications may be even more valuable to the merchant. The desired classifications may be communicated using an API or may be communicated using a known protocol which may result in efficient and effective communications between the merchant and the data provider.

At block 215, the classifications may be stored in a user classification database. The classification database may be used to assist in creating current offers or discounts and may be used to create offers and discounts in the future. In some embodiments, the classifications may be updated less frequently and the stored classifications may be used without requiring a heavy computing analysis.

At block 220, transit data for the user may be received. The transit data may contain numerous elements such as:
a first location such as where a user entered the public transportation system,
a first time such as when a user entered the public transportation system,
a second location such as where a user exited the public transportation system, and
a second time such as when a user exited the public transportation system.

Of course, additional data elements may be part of the transit data such as the type of transport used, whether any discounts were used, how long the trip took, what method the commuter used to pay, etc.

At block 225, possible transit paths from the first location to the second location may be analyzed. FIG. 7 may be a graphical representation of the analysis. The first location and the second location may both be on a train line and that may be a possible transit path. In addition, a bus may pass near the first location and with the proper bus transfers, a path to the second location may be determined. The logical transportation paths and variations thereof may be determined and stored in a memory.

FIG. 7 may illustrate possible transit paths on a map 700. The map may illustrate a starting point 705 and an ending point 710. Alternative transit paths between the first location and the second location may be illustrated such as path 715 and 720. In some embodiments, the first time such as when a journey begins and a second time such as when a journey may end may also be illustrated.

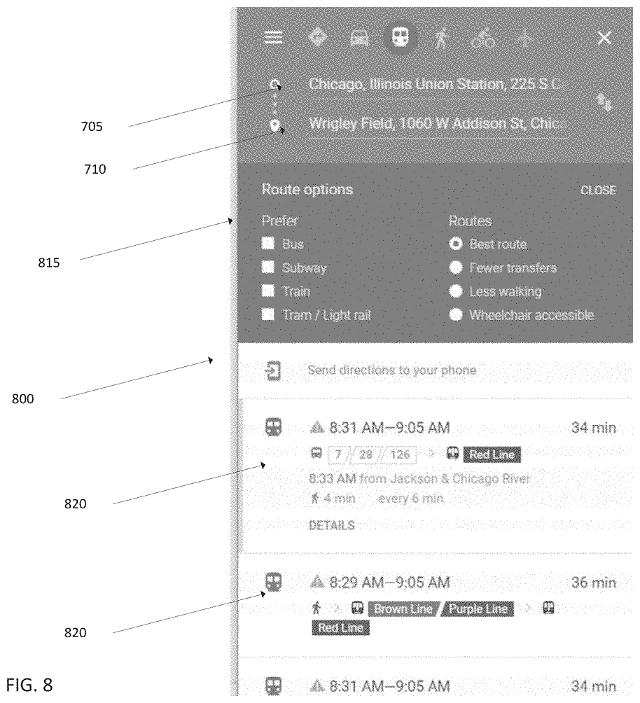

FIG. 8 may be an illustration where the possible paths 715 720 may be analyzed. A starting point 705 and the end point 710 may be entered. At block 815, a user may make selections 815 regarding what would be the best path. For example, some people may enjoy light rail while others may enjoy riding a bus. Path options 820 may then be listed along with a description of the details of the path such as the type of transportation and the time each may take.

At block 230, a ranking of likely transit paths from the first location to the second location may be determined. The determination may occur in many ways. In one embodiment, the paths may be ranked according to the shortest to longest distance of the various possible the routes. In another embodiment, the paths may be ranked according to the lowest estimated time of the various possible routes. In yet another embodiment, the paths may be ranked according to the lowest number of transportation changes. In yet another embodiment, the paths may be ranked according to the lowest cost. In yet another embodiment, transit statistics may be reviewed to match most common paths to the first and second location. In addition, the different embodiments may be combined in whole or in part to create a combination of factors to create the ranking of the paths. Further, in some embodiment, the ranking methodology may be provided by others such as transit planners who watch travel patterns, from survey results collected in the past or from another source. If the ranking algorithm fails, the data may be reordered and the ranking may occur again.

In one embodiment, determining a ranking of likely transit paths from the first location to the second location may include receiving transit data such as a set of first travel locations, first travel times, second travel locations and second travel times. The transit data may be stored in a memory. Based on public transportation reports which path is possible, possible paths may be determined. For example, some rural locations may only be reached by a single bus line. Logically, if one of the first location or second location is a rural location, the bus line may logically be part of the transit path. Similarly, if a train line goes east and west, it is extremely unlikely the east and west train line was used by a passenger that traveled north and south. Next, based on the determination of which path is possible, the most likely path may be determined and, as described previously, that determination may take on many forms.

As an example, the method and system may analyze users that purchased public transportation and goods/services from a service provider at a service provider location during a similar time period. As illustrated in FIG. 7, the analysis may determine a possible path that includes the first location 705, a service provider location and the second location 710. For example, there may be several road based paths the connect the first location 705 and the second location 710 and pass the service provider location. Public transportation routes that similar to the possible path may be determined. By combining bus, train, tram, light rail and other public transportation paths, the various routes may be determined. The various public transportation routes may be ranked as a likely transportation routes. As mentioned previously, a route that takes a significantly longer time than other route may be ranked low. Similarly, a route that takes significantly less time than other routes may be ranked high. And as mentioned previously, the ranking of routes may take many forms, take in many variables and those variables may be weighted different depending on the user and the purpose of the user.

At block 235, service providers along a highest ranked path may be analyzed to create a relevant service provider list to determine service providers that may be interested in creating offers or discounts for commuters on the highest ranked path. For example, a coffee shop on a morning bus route to downtown may be interested in advertising to commuters that commute downtown on the path past the coffee shop. Similarly, a flower shop that is nowhere near a commuter route may not be interested in advertising to commuters.

At block 240, for the service providers on the relevant service provider list, service provider communications such as offers or sales which match the classifications for the user may be determined. As mentioned previously, the buying habits of commuters may be different and different commuters may be of interest to different merchants. For example, discount merchants may want to offer sales to discount shoppers that commute past the discount store and high end stores may want to advertise to high end customers that commute past the high end store.

The transit data may be used in several ways. In some embodiments, the merchant may specifically request a type of commuter to be targeted with communications. For example, an inquiry from a service provider may be received for users that meet a given criteria. A set of users from a user set may be determined that meet the criteria. The set of users may be anonymized and the details on the set of users may be communicated to the service provider. In some embodiments, the criteria is created by the merchant. The merchant may communicate the criteria using an API or by using a protocol that is known to users of the system. If the communication determination decision fails, the data may be reordered and the decision process may occur again.

At block 245, a display time may be determined such that the communication will be delivered at a time when the commuter is before or near the merchant location. For example. a time at which a user will pass a first service provider in a relevant range of the highest ranked path may be determined and the communication may be delivered at or near that time. If the display time determination fails, the data may be reloaded and the decision process may occur again.

At block 250, the service provider communications may be communicated to the user at the display time. The communication may take on a form that is logical in view of the devices being carried by a user. In some embodiments, the user type device may be determined. If the commuter has a smart phone type of portable computing device, an email or text may be appropriate. In other situations, the commuter may have a larger screen with more computing power and a more graphically rich communication may be used.

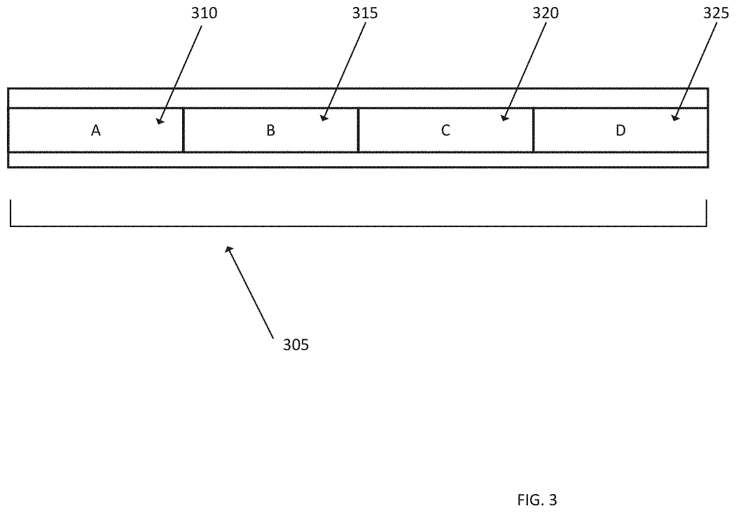

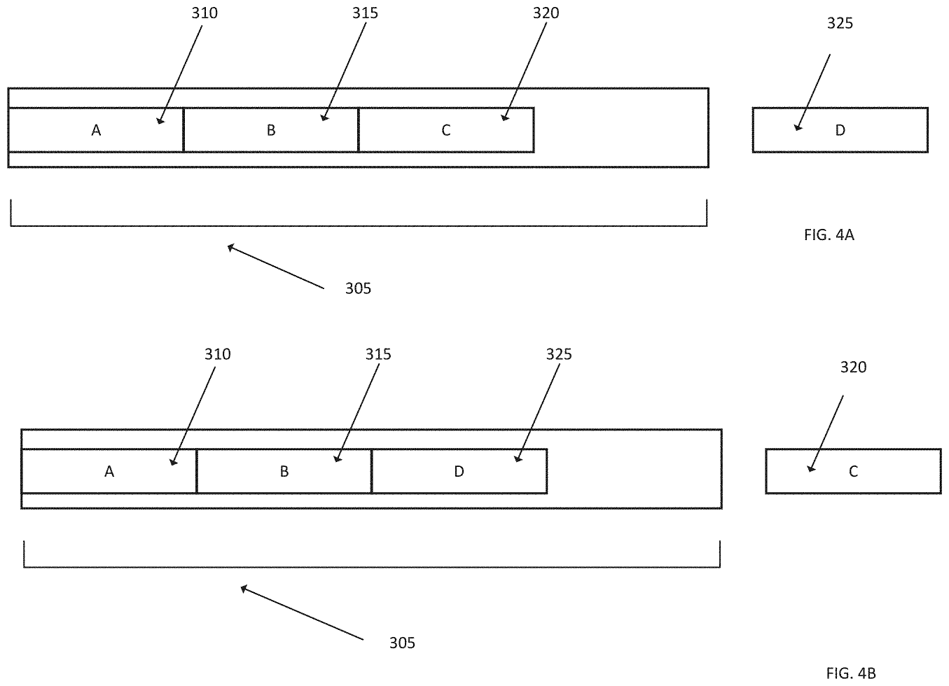

In some embodiments, machine learning may be used to improve the selection of routes and the selection of communications. Machine learning may entail reviewing past data to determine how to better handle data in the future. FIG. 3 may illustrate a sample machine learning system. As an example and not a limitation, an artificial intelligence system may trained by analyzing a set of training data 305. The training data may be broken into sets, such as set A 310, set B 315, set C 320 and set D 325. As illustrated in FIG. 4A, one set ma y be using as a testing set (say set D 325) and the remaining sets may be used as training set (set A 310, set B 315 and set C 320). The artificial intelligence system may analyze the training set (set A 310, set B 315 and set C 320) and use the testing set (set D 325) to test the model create from the training data. Then the data sets may shift as illustrated in FIG. 4B, where the test data set may be added to the training data sets (say set A 310, set B 315 and set D 325) and one of the training data sets that have not been used to test before (say set C 320) may be used as the test data set. The analysis of the training data (set A 310, set B 315 and set D 325) may occur again with the new testing set (set C 320) being used to test the model and the model may be refined. The rotation of data sets may occur repeatedly until all the data sets have been used as the test data sets. The model then may be considered complete and the model may then be used on additional data sets.

In one example in how machine learning may be applied to communications, responses may be received from the user to the service provider communications. The responses may include an affirmative response such as using an offer, a decline to use the offer such as an “unsubscribe” response or that the offer was simply ignored. The responses may be stored in a memory such as a database. An algorithm made be used which learns from relevant input data sets to analyze the responses. The responses may be ranked according to a response ranking criteria. The response ranking criteria may be set by the merchant. For an example, a merchant may desire customers which may result in more money but an overly aggressive offer may result in the merchant losing money. Similarly, an offer which does not generate any response may not be especially useful to a merchant. Based on the analysis, future communications may be adjusted based on the ranking of the responses.

A user interface may also be created. The user interface may allow a merchant to adjust criteria that may be used to target commuters that may have opted to receive offers or communications. The criteria may be created using drop down boxes that have common characteristics of commuters. The merchant may be able to rank or select characteristics which may be used to assist in identifying customers to receive a communication.

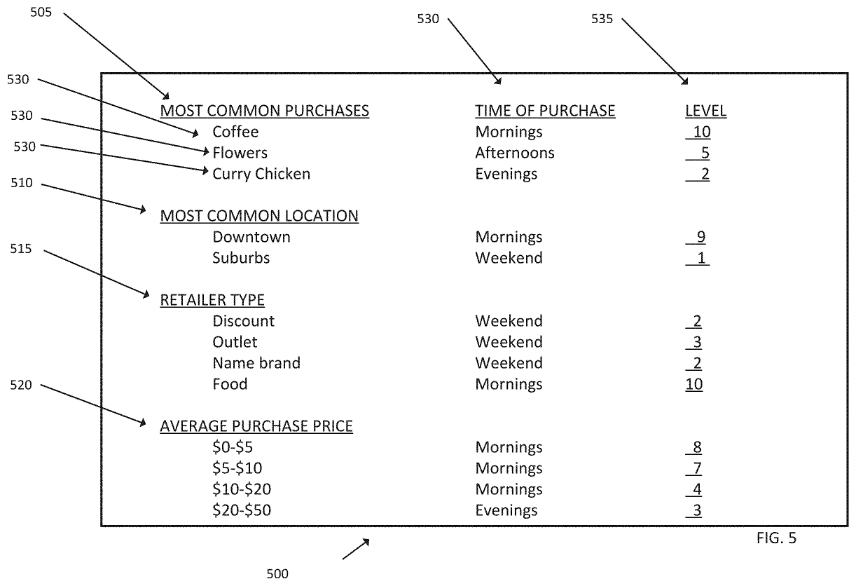

FIG. 5 may be a sample user interface 500. Some examples and not limitations of criteria that a merchant may adjust include MOST COMMON PURCHASE 505, MOST COMMON LOCATION 510, RETAILER TYPE 515 and AVERAGE PURCHASE PRICE 520. Under each criteria may be criteria elements 530. In addition, in some embodiments, the time of the purchase may be listed which may matter to merchants that are only open part of the day. The criteria elements 530 may be given weights or levels 535 which may indicate the importance of each element to the particular merchant. The weights may be used to better target consumers that have indicated they would accept communications from merchants.

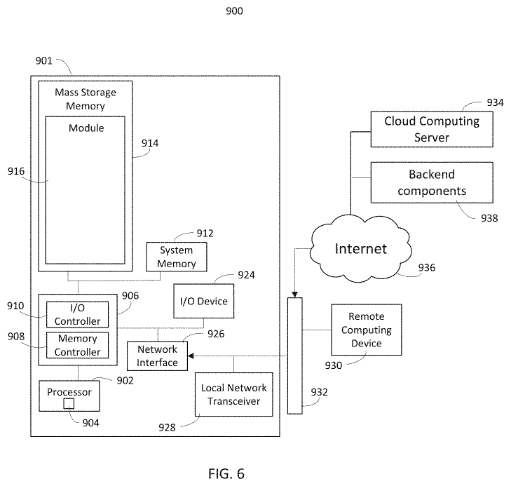

As illustrated in FIG. 1, many computers may be used by the system. FIG. 6 may illustrate a sample computing device 901. The computing device 901 includes a processor 902 that is coupled to an interconnection bus. The processor 902 includes a register set or register space 904, which is depicted in FIG. 6 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 6, the computing device 901 may be a multi-processor device and, thus, may include one or more additional processors that are identical or similar to the processor 902 and that are communicatively coupled to the interconnection bus.

The processor 902 of FIG. 6 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein. The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 6 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 6 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general -purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer system comprising a server including one or more processors, the one or more processors programmed or configured for computer based offer determination comprising:
receiving transaction data for a user;
determining classifications of the user based on the transaction data;
storing the classifications in a user classification database;
receiving transit data for the user wherein the transit data comprises at least one of:
a first location;
a first time;
a second location; and
a second time;
analyzing possible transit paths from the first location to the second location;
determining a ranking of likely transit paths from the first location to the second location;
analyzing service providers along a highest ranked path to create a relevant service provider list;
for the service providers on the relevant service provider list:
determining service provider communications (offers/sales) which match the classifications for the user;
determining a display time comprising determining a time at which a user will pass a first service provider in a relevant range of the highest ranked path; and
communicating the service provider communications to the user at the display time.

2. The computer system of claim 1, further comprising:
receiving responses from the user to the service provider communications;
storing the responses in a memory;
using an algorithm which learns from relevant input data sets to analyze the responses;
ranking the responses; and
adjusting future communications based on the ranking of the responses.

3. The computer system of claim 1, further comprising:
receiving an inquiry from a service provider for users that meet criteria;
determining a set of users from a user set that meet the criteria;
anonymizing the set of users; and
communicating details on the set of users to the service provider.

4. The computer system of claim 3, further comprising
selecting a communication for the service provider that matches the criteria; and
communicating the communication that was selected to the set of users.

5. The computer system of claim 1, wherein determining classifications of the user based on the transaction data further comprises:
receiving a set of transaction data for a plurality of users;
using an algorithm which learns from past relevant data sets to perform an analysis of the transaction data for the users according to a criteria;
separating the plurality of users into groups based on the analysis.

6. The computer system of claim 5, wherein the criteria is created by a service provider.

7. The computer system of claim 1 wherein determining a ranking of likely transit paths from the first location to the second location further comprises:
receiving a set of first travel locations, first travel times, second travel locations and second travel times;
determining based on public transportation reports which path is possible; and
determining based on which path is possible, which path which is most likely.

8. The computer system of claim 7, further comprising:
analyzing users that purchased public transportation and goods/services from a service provider at a service provider location during a similar time period;
determining a possible path that includes the first location, the service provider location and the second location;
determining public transportation route that similar to the possible path; and
ranking the public transportation route as a likely transportation route.

9. A computer based method for physically configuring a processor for computer based offer determination comprising computer executable blocks for:
receiving transaction data for a user;
determining classifications of the user based on the transaction data;
storing the classifications in a user classification database;
receiving transit data for the user wherein the transit data comprises at least one of:
a first location;
a first time;
a second location; and
a second time;
analyzing possible transit paths from the first location to the second location;
determining a ranking of likely transit paths from the first location to the second location;
analyzing service providers along a highest ranked path to create a relevant service provider list;
for the service providers on the relevant service provider list:
determining service provider communications (offers/sales) which match the classifications for the user;
determining a display time comprising determining a time at which a user will pass a first service provider in a relevant range of the highest ranked path; and
communicating the service provider communications to the user at the display time.

10. The computer based method of claim 9, further comprising:
receiving responses from the user to the service provider communications;
storing the responses in a memory;
using an algorithm which learns from relevant input data sets to analyze the responses;
ranking the responses; and
adjusting future communications based on the ranking of the responses.

11. The computer based method of claim 9, further comprising:
receiving an inquiry from a service provider for users that meet criteria;
determining a set of users from a user set that meet the criteria;
anonymizing the set of users; and
communicating details on the set of users to the service provider.

12. The computer based method of claim 11, further comprising
selecting a communication for the service provider that matches the criteria; and
communicating the communication that was selected to the user set.

13. The computer based method of claim 9, wherein determining classifications of the user based on the transaction data further comprises:
receiving a set of transaction data for a plurality of users;
using an algorithm which learns from past relevant data sets to perform an analysis of the transaction data for the users according to a criteria;
separating the plurality of users into groups based on the analysis.

14. The computer based method of claim 11, wherein the criteria is created by a service provider.

15. The computer based method of claim 9, wherein determining a ranking of likely transit paths from the first location to the second location further comprises:
receiving a set of first travel locations, first travel times, second travel locations and second travel times;
determining based on public transportation reports which path is possible; and
determining based on which path is possible, which path which is most likely.

16. The computer based method of claim 15, further comprising:
analyzing users that purchased public transportation and goods/services from a service provider at a service provider location during a similar time period;
determining a possible path that includes the first location, the service provider location and the second location;
determining public transportation route that similar to the possible path; and
ranking the public transportation route as a likely transportation route.

17. A tangible computer readable medium comprising computer readable instruction for determining computer based offers, the instructions comprising computer blocks for:
receiving transaction data for a user;
determining classifications of the user based on the transaction data;
storing the classifications in a user classification database;
receiving transit data for the user wherein the transit data comprises at least one of:
a first location;
a first time;
a second location; and
a second time;
analyzing possible transit paths from the first location to the second location;
determining a ranking of likely transit paths from the first location to the second location;
analyzing service providers along a highest ranked path to create a relevant service provider list;
for the service providers on the relevant service provider list:
determining service provider communications (offers/sales) which match the classifications for the user;
determining a display time comprising determining a time at which a user will pass a first service provider in a relevant range of the highest ranked path; and
communicating the service provider communications to the user at the display time.

18. The tangible computer readable medium of claim 17, further comprising blocks for:
receiving responses from the user to the service provider communications;
storing the responses in a memory;
using an algorithm which learns from relevant input data sets to analyze the responses;
ranking the responses; and
adjusting future communications based on the ranking of the responses.

19. The tangible computer readable medium of claim 17, further comprising blocks for:
receiving an inquiry from a service provider for users that meet criteria;
determining a set of users from a user set that meet the criteria;
anonymizing the set of users; and
communicating details on the set of users to the service provider.

20. The tangible computer readable medium of claim 17, wherein determining a ranking of likely transit paths from the first location to the second location further comprises:
receiving a set of first travel locations, first travel times, second travel locations and second travel times;
determining based on public transportation reports which path is possible;
determining based on which path is possible, which path which is most likely;
analyzing users that purchased public transportation and goods/services from a service provider at a service provider location during a similar time period;
determining a possible path that includes the first location, the service provider location and the second location;
determining public transportation route that similar to the possible path; and
ranking the public transportation route as a likely transportation route.
